(19) United States
(12) Patent Application Publication
(10) Pub. No.: US 2024/0409711 A1
(43) Pub. Date: Dec. 12, 2024

(54) MULTI-COMPONENT FILAMENT AND OTHER POLYMERIC MATERIALS PROVIDING ANTIMICROBIAL ACTIVITY

(71) Applicant: CORNING INCORPORATED, CORNING, NY (US)

(72) Inventors: Theresa Chang, Painted Post, NY (US); William Keith Fisher, Corning, NY (US)

(21) Appl. No.: 18/691,348

(22) PCT Filed: Sep. 16, 2022
(86) PCT No.: PCT/US2022/043745

§ 371 Date: Mar. 12, 2024

Related U.S. Application Data
(60) Provisional application No. 63/245,398, filed on Sep. 17, 2021.

(51) Int. Cl. C08K 3/40

(52) U.S. Cl. CPC C08K 3/40

(57) ABSTRACT

A multi-component filament including: (a) a first component comprising a first polymer, the first component extending longitudinally along a length of the multi-component filament; and (b) a second component comprising a second polymer, copper-containing particles dispersed throughout the second polymer, and copper-containing ions disposed throughout the second polymer, the second component extending longitudinally along the length of the multi-component filament. The second polymer can be one or more of polyethyleneimine, a nylon, an aramid precursor polymer, polyetherimide, a polyamide-imide, polystyrene, poly(methyl methacrylate), polyimide, melamine resin, urea-formaldehyde, polyacrylonitrile, a copolyimide, an amide-containing polymer, a pyrrole-containing polymer, or an indole-containing polymer. The second component can further include an additive, such as one or more of 2-ethylhexylphosphate, imidazole, benzoxazole, benzimidazole, benzothiazole, benzopyrrole, phthalimide, urea, a nitrile, imidazole, a C pyrrole, an indole, a maleimide, a succinimide, an organo-phosphate, an organo-phosphite, or an organo-phosphonate, among others. A method of manufacturing the multi-component filament is disclosed.

### CROSS-REFERENCE TO RELATED APPLICATION

This application claims priority to and the benefit of and priority to U.S. Provisional Patent Application No. 63/245,398, filed 17 Sep. 2021, and titled “MULTI-COMPONENT FILAMENT WITH A LONGITUDINALLY EXTENDING COMPONENT HAVING COPPER-CONTAINING PARTICLES AND COPPER-CONTAINING IONS DISPERSED THROUGHOUT A POLYMER TO PROVIDE ANTIMICROBIAL ACTIVITY AND METHOD OF MAKING THE SAME,” and the application is incorporated herein by reference in its entirety.

### FIELD OF THE DISCLOSURE

This disclosure pertains to the field of polymers, such as multi-component polymeric filaments, exhibiting antimicrobial activity.

### BACKGROUND

A surface may harbor viruses and microbes and facilitate the transfer of the viruses and microbes from one person to another person. A polymeric material, such as a polymeric textile, sometimes provides such a surface. The textile is sometimes part of a seating assembly, flooring, and so on. The textile in some instances is disposed within high-traffic environments, such as office buildings, transportation hubs, and transportation vehicles.

Efforts have been made to disperse particles of an antimicrobial material into melt spun fiber. However, dispersing the particles within the fiber is difficult and results in low yields. In addition, the fiber with such particles has low strength during formation and thus readily breaks during formation. Further, even non-fibrous polymeric surfaces to date have shown an inability to provide anything beyond short-term antimicrobial activity.

### SUMMARY

The present disclosure addresses those problems with a polymeric material that includes a polymer and copper-containing ions dispersed throughout the polymer. The copper-containing ions can derive from copper-containing particles additionally dispersed throughout the polymer, or can be dispersed throughout the polymer upon precipitation of the polymer from one or more solvents also containing the copper-containing ions. The composition of the polymer can assist in extracting copper-containing ions from the copper-containing particles. Further, the polymeric material can further include an additive that has a composition that facilitates the extraction of the copper-containing ions from the copper-containing particles. Even if the polymeric material lacks copper-containing particles, the additive can facilitate the migration of the copper-containing ions to a surface of the polymeric material to provide prolonged anti-microbial activity. In any event, the copper-containing ions impart antimicrobial activity to the polymeric material. When the polymeric article includes the copper-containing particles, the copper-containing particles are a reservoir for continued release of copper-containing ions into the polymeric material to prolong the antimicrobial efficacy of the polymeric material. The polymeric material can be a coating on a substrate.

In other instances, the polymeric material can be one or both of the filaments of a multi-component filament. A first component and a second component are co-extruded together into the multi-component filament. The first component includes a first polymer that imparts sufficient strength to the multi-component filament to survive without breaking during formation. The second component is a composite of a second polymer, copper-containing ions, and, in some instances, copper-containing particles. The second polymer, and/or an additive added to second component, extracts copper-containing ions (e.g., Cu¹⁺ ions) from the copper-containing particles and/or facilitates the migration of copper-containing ions through the second polymer and to a surface of the multi-component filament. Thus, the copper-containing particles provide a reservoir of copper-containing ions that can be extracted and thereafter migrate to the surface of the multi-component filament. The presence of the copper-containing ions at the surface of the multi-component filament provides the multi-component filament with antimicrobial activity. The multi-component filament can be one of a plurality of such multi-component filaments from which a textile is formed. The textile has the antimicrobial properties that the copper-containing ions impart.

According to a first aspect of the present disclosure, a multi-component filament comprises: (a) a first component comprising a first polymer, the first component extending longitudinally along a length of the multi-component filament; and (b) a second component comprising a second polymer, copper-containing particles dispersed throughout the second polymer, and copper-containing ions disposed throughout the second polymer, the second component extending longitudinally along the length of the multi-component filament.

According to a second aspect of the present disclosure, the multi-component filament of the first aspect, wherein the first polymer comprises a nylon.

According to a third aspect of the present disclosure, the multi-component filament of the first aspect is presented, wherein the first polymer comprises one or more of nylon 6 or nylon 66.

According to a fourth aspect of the present disclosure, the multi-component filament of the first aspect is presented, wherein the first polymer comprises one or more of a polyester, polypropylene, or polyethylene.

According to a fifth aspect of the present disclosure, the multi-component filament of any one of the first through fourth aspects is presented, wherein the second polymer comprises one or more of polyethyleneimine, a nylon, an aramid precursor polymer, polyetherimide, a polyamide-imide, polystyrene, poly(methyl methacrylate), polyimide, melamine resin, urea-formaldehyde, polyacrylonitrile, a copolyimide, an amide-containing polymer, a pyrrole-containing polymer, or an indole-containing polymer.

According to a sixth aspect of the present disclosure, the multi-component filament of any one of the first through fifth aspects is presented, wherein (a) the second component further comprises an additive dispersed throughout the second polymer; and (b) the additive is one or more of 2-ethylhexylphosphate, imidazole, benzoxazole, benzimidazole, benzothiazole, benzopyrrole, phthalimide, urea, a nitrile, imidazole, a pyrrole, an indole, a maleimide, a succinimide, an organo-phosphate, an organo-phosphite, or an organo-phosphonate.

According to a seventh aspect of the present disclosure, the multi-component filament of any one of the first through fifth aspects is presented, wherein (a) the second component further comprises an additive dispersed throughout the second polymer; and (b) the additive is one or more of N-methyl-2-pyrrolidone, dimethylformamide, acetamide, formamide, 2-pyrrolidone, N-formylmorpholine, urea, β-propiolactam, δ-valerolactam, ε-caprolactam, acetonitrile, and benzonitrile.

According to an eighth aspect of the present disclosure, the multi-component filament of any one of the first through fifth aspects is presented, wherein (a) the first component further comprises an additive dispersed throughout the first polymer; (b) the second component further comprises an additive dispersed throughout the second polymer; and (c) the additives comprise one or more of N-methyl-2-pyrrolidone, dimethylformamide, acetamide, formamide, 2-pyrrolidone, N-formylmorpholine, urea, β-propiolactam, δ-valerolactam, ε-caprolactam, acetonitrile, benzonitrile, 2-ethylhexylphosphate, imidazole, benzoxazole, benzimidazole, benzothiazole, benzopyrrole, phthalimide, urea, a nitrile, imidazole, a pyrrole, an indole, a maleimide, a succinimide, an organo-phosphate, an organo-phosphite, and an organo-phosphonate.

According to a ninth aspect of the present disclosure, the multi-component filament of any one of the first through eighth aspects is presented, wherein at least a portion of the copper-containing ions is in a state of migration from the second component into the first component.

According to a tenth aspect of the present disclosure, the multi-component filament of any one of the first through eighth aspects is presented, wherein at least a portion of the copper-containing ions is in a state of migration from the second component to a surface of the multi-component filament facing an environment external to the multi-component filament, and the first component provides the surface.

According to an eleventh aspect of the present disclosure, the multi-component filament of any one of the first through eighth aspects further comprises: (a) a first state, wherein a surface of the multi-component filament facing an environment external to the multi-component filament is substantially free of copper-containing ions; and (b) a second state, occurring after the first state, wherein a portion of the copper-containing ions is disposed at the surface of the multi-component filament facing the environment external to the multi-component filament.

According to a twelfth aspect of the present disclosure, the multi-component filament of any one of the first through eighth aspects is presented, wherein the second component radially surrounds the first component throughout the length of the multi-component filament.

According to a thirteenth aspect of the present disclosure, the multi-component filament of any one of the first through eleventh aspects is presented, wherein the first component surrounds the second component throughout the length of the multi-component filament.

According to a fourteenth aspect of the present disclosure, the multi-component filament of any one of the first through thirteenth aspects is presented, wherein the copper-containing particles have a median diameter within a range of 1 μm to 5 μm.

According to a fifteenth aspect of the present disclosure, the multi-component filament of any one of the first through fourteenth aspects is presented, wherein the copper-containing particles comprise one or more of a glass, a glass-ceramic, cuprite crystals, metallic copper, copper oxide, and a copper salt.

According to a sixteenth aspect of the present disclosure, the multi-component filament of any one of the first through fourteenth aspects is presented, wherein the copper-containing particles comprise a glass or glass-ceramic, and copper-containing ions as part of a glass network of the glass or glass-ceramic.

According to a seventeenth aspect of the present disclosure, the multi-component filament of any one of the first through fourteenth aspects is presented, wherein the copper-containing particles comprise a glass-ceramic comprising cuprite crystals.

According to an eighteenth aspect of the present disclosure, the multi-component filament of any one of the first through fourteenth aspects is presented, wherein (a) the copper-containing particles comprise a glass or a glass-ceramic comprising (i) a first glass phase comprising SiO₂ and (ii) a second glass phase comprising one or more of B₂O₃, P₂O₅, and R₂O, where R is one or more of K, Na, Li, Rb, and Cs; and (b) the copper-containing particles further comprise copper-containing ions disposed in one or more of the first glass phase and the second glass phase.

According to a nineteenth aspect of the present disclosure, the multi-component filament of any one of the first through fourteenth aspects is presented, wherein (a) the copper-containing particles comprise a glass or a glass-ceramic; and (b) the copper-containing particles comprise a greater percentage of Cu¹⁺ ions and Cu⁰ than Cu²⁺ ions.

According to a twentieth aspect of the present disclosure, a method of manufacturing a multi-component filament comprises: coextruding (A) a first molten stock comprising a first polymer and (B) a composite comprising (i) a second polymer in a molten state, and (ii) copper-containing particles dispersed throughout the second polymer, thereby forming a multi-component filament comprising a first component from the first molten stock extending longitudinally along a length of the multi-component filament and a second component from the composite also extending longitudinally along the length of the multi-component filament; wherein, one or more of the second polymer and an additive dispersed throughout the second polymer comprise a nitrogen with a lone pair of electrons.

According to a twenty-first aspect of the present disclosure, the method of the twentieth aspect further comprises forming the copper-containing particles by: (i) forming a glass or glass-ceramic by melting a batch comprising (on an oxide basis, in mol %): SiO₂: 40 to 70; copper-containing oxide: 17.5 to 40; and greater than 0 mol % of one or more of Al₂O₃, B₂O₃, P₂O₅, and R₂O (where R₂O is one or more of Li₂O, Na₂O, K₂O, Rb₂O, and Cs₂O); and (ii) segmenting the glass or glass-ceramic into the copper-containing particles.

According to a twenty-second aspect of the present disclosure, the method of any one of the twentieth through twenty-first aspects further comprises forming a textile comprising the multi-component filament.

According to a twenty-third aspect of the present disclosure, the method of any one of the twentieth through twenty-second aspects is presented, wherein the composite comprises copper-containing particles within a range of 1 wt % to 20 wt %.

According to a twenty-fourth aspect of the present disclosure, the method of any one of the twentieth through twenty-third aspects is presented, wherein the second component is 1% to 30% of a cross-sectional area of the multi-component filament.

According to a twenty-fifth aspect of the present disclosure, the method of any one of the twentieth through twenty-fourth aspects is presented, wherein the second polymer comprises one or more of polyethyleneimine, a nylon, an aramid precursor polymer, polyetherimide, a polyamide-imide, polystyrene, poly(methyl methacrylate), polyimide, melamine resin, urea-formaldehyde, polyacrylonitrile, a copolyimide, an amide-containing polymer, a pyrrole-containing polymer, and an indole-containing polymer.

According to a twenty-sixth aspect of the present disclosure, the method of any one of the twentieth through twenty-fifth aspects is presented, wherein the additive comprises one or more of N-methyl-2-pyrrolidone, dimethylformamide, acetamide, formamide, 2-pyrrolidone, N-formylmorpholine, urea, β-propiolactam, δ-valerolactam, ε-caprolactam, acetonitrile, and benzonitrile.

According to a twenty-seventh aspect of the present disclosure, the method of any one of the twentieth through twenty-sixth aspects is presented, wherein the additive comprises one or more of 2-ethylhexylphosphate, imidazole, benzoxazole, benzimidazole, benzothiazole, benzopyrrole, phthalimide, urea, a nitrile, imidazole, a pyrrole, an indole, a maleimide, a succinimide, an organo-phosphate, an organo-phosphite, and an organo-phosphonate.

According to a twenty-eighth aspect of the present disclosure, the method of any one of the twentieth through twenty-eighth aspects is presented, wherein (i) the first molten stock further comprises an additive dispersed throughout the first polymer that is capable of facilitating the migration of copper-containing ions throughout the first polymer; and (ii) the additive of the first molten stock and the composite comprises one or more of N-methyl-2-pyrrolidone, dimethylformamide, acetamide, formamide, 2-pyrrolidone, N-formylmorpholine, urea, β-propiolactam, δ-valerolactam, ε-caprolactam, acetonitrile, benzonitrile, 2-ethylhexylphosphate, imidazole, benzoxazole, benzimidazole, benzothiazole, benzopyrrole, phthalimide, urea, a nitrile, imidazole, a pyrrole, an indole, a maleimide, a succinimide, an organo-phosphate, an organo-phosphite, and an organo-phosphonate.

According to a twenty-ninth aspect of the present disclosure, a polymeric material comprises: a polymer; and ions of a copper nitrile complex dispersed throughout the polymer.

According to a thirtieth aspect of the present disclosure, the polymeric material of the twenty-ninth aspect is presented, wherein the polymer is one or more of a nylon, polyvinyl chloride, a polyester, polybutylene terephthalate, polypropylene, polyethylene, polyethyleneimine, an aramid precursor polymer, polyetherimide, a polyamide-imide, polystyrene, poly(methyl methacrylate), polyimide, melamine resin, urea-formaldehyde, polyacrylonitrile, a copolyimide, an amine-containing polymer, an amide-containing polymer, an imide-containing polymer, a pyrrole-containing polymer, and an indole-containing polymer.

According to a thirty-first aspect of the present disclosure, the polymeric material of the twenty-ninth aspect is presented, wherein the polymer is one or more of an amine-containing polymer, an amide-containing polymer, and an imide-containing polymer.

According to a thirty-second aspect of the present disclosure, the polymeric material of any one of the twenty-ninth through thirty-first aspects further comprises an additive dispersed throughout the polymer, the additive comprising a nitrogen with a lone pair of electrons.

According to a thirty-third aspect of the present disclosure, the polymeric material of any one of the twenty-ninth through thirty-first aspects further comprises an additive dispersed throughout the polymer, the additive comprising one or more of 2-ethylhexylphosphate, imidazole, benzoxazole, benzimidazole, benzothiazole, benzopyrrole, phthalimide, urea, a nitrile, imidazole, a pyrrole, an indole, a maleimide, a succinimide, an organo-phosphate, an organo-phosphite, and an organo-phosphonate.

According to a thirty-fourth aspect of the present disclosure, the polymeric material of any one of the twenty-ninth through thirty-first aspects further comprises an additive dispersed throughout the polymer, the additive comprising one or more of N-methyl-2-pyrrolidone, dimethylformamide, acetamide, formamide, 2-pyrrolidone, N-formylmorpholine, urea, β-propiolactam, δ-valerolactam, ε-caprolactam, acetonitrile, and benzonitrile.

According to a thirty-fifth aspect of the present disclosure, the polymeric material of any one of the twenty-ninth through thirty-fourth aspects is presented, wherein the ions of copper nitrile complex are [Cu(CH₃CN)₄]⁺.

According to a thirty-sixth aspect of the present disclosure, the polymer material of any one of the twenty-ninth through thirty-fifth aspects is presented, wherein (i) the polymeric material is a coating over a substrate; and (ii) the polymeric material provides a surface open to an external environment.

According to a thirty-seventh aspect of the present disclosure, the polymeric material of any one of the twenty-ninth through thirty-sixth aspects is presented, wherein the polymeric material exhibits a 3 log reduction or greater in a concentration of at least one of Staphylococcus aureus and Pseudamonas aeruginosa, under Modified JIS Z 2801 for Bacteria testing conditions.

According to a thirty-eighth aspect of the present disclosure, the polymeric material of any one of the twenty-ninth through thirty-sixth aspects is presented, wherein after 7 days of accelerated aging at 65° C. and 65% relative humidity, the polymeric material exhibits a 3 log reduction or greater in a concentration of at least one of Staphylococcus aureus and Pseudamonas aeruginosa, under Modified JIS Z 2801 for Bacteria testing conditions.

According to a thirty-ninth aspect of the present disclosure, the polymeric material of any one of the twenty-ninth through thirty-sixth aspects is presented, wherein after 7 days of accelerated aging at 65° C. and 65% relative humidity, the polymeric material exhibits a 5 log reduction or greater in a concentration of at least one of Staphylococcus aureus and Pseudamonas aeruginosa, under Modified JIS Z 2801 for Bacteria testing conditions.

According to a fortieth aspect of the present disclosure, a polymeric material comprises: (i) a polymer; (ii) copper-containing particles dispersed throughout the polymer; (iii) copper-containing ions dispersed throughout the polymer; and (iv) an additive dispersed throughout the polymer, the additive selected from the group consisting of N-methyl-2-pyrrolidone, dimethylformamide, acetamide, formamide, 2-pyrrolidone, N-formylmorpholine, urea, β-propiolactam, δ-valerolactam, ε-caprolactam, acetonitrile, benzonitrile, 2-ethylhexylphosphate, imidazole, benzoxazole, benzimidazole, benzothiazole, benzopyrrole, phthalimide, urea, a nitrile, imidazole, a pyrrole, an indole, a maleimide, a succinimide, an organo-phosphate, an organo-phosphite, and an organo-phosphonate.

According to a forty-first aspect of the present disclosure, the polymeric material of the fortieth aspect is presented, wherein the polymer is one or more of a nylon, polyvinyl chloride, a polyester, polybutylene terephthalate, polypropylene, polyethylene, polyethyleneimine, an aramid precursor polymer, polyetherimide, a polyamide-imide, polystyrene, poly(methyl methacrylate), polyimide, melamine resin, urea-formaldehyde, polyacrylonitrile, a copolyimide, an amine-containing polymer, an amide-containing polymer, an imide-containing polymer, a pyrrole-containing polymer, and an indole-containing polymer.

According to a forty-second aspect of the present disclosure, the polymeric material of the fortieth aspect is presented, wherein the polymer is one or more of an amine-containing polymer, an amide-containing polymer, and an imide-containing polymer.

According to a forty-third aspect of the present disclosure, the polymeric material of any one of the fortieth through forty-second claims is presented, wherein the copper-containing particles comprise one or more of a glass, a glass-ceramic, cuprite crystals, metallic copper, copper oxide, and a copper salt.

According to a forty-fourth aspect of the present disclosure, the polymeric material of the forty-third aspect is presented, wherein (i) the copper-containing particles comprise a glass or glass-ceramic, and (ii) the glass or glass-ceramic is 30 wt % to 50 wt % of the polymeric material.

According to a forty-fifth aspect of the present disclosure, the polymeric material of the forty-third aspect is presented, wherein (i) the copper-containing particles comprise a copper salt, and (ii) the copper salt is a salt of a copper nitrile complex.

According to a forty-sixth aspect of the present disclosure, the polymeric material of the forty-fifth aspect is presented, wherein the copper salt is tetrakis(acetonitrile)copper(I) hexafluorophosphate.

According to a forty-seventh aspect of the present disclosure, the polymeric material of the forty-fifth aspect is presented, wherein the copper salt is within a range of from 0.5 wt % to 5 wt % of the polymeric material.

According to a forty-eighth aspect of the present disclosure, the polymeric material of any one of the fortieth through forty-sixth aspects is presented, wherein the polymeric material exhibits a 3 log reduction or greater in a concentration of at least one of Staphylococcus aureus and Pseudamonas aeruginosa, under Modified JIS Z 2801 for Bacteria testing conditions.

According to a forty-ninth aspect of the present disclosure, the polymeric material of any one of the fortieth through forty-sixth aspects is presented, wherein after 7 days of accelerated aging at 65° C. and 65% relative humidity, the polymeric material exhibits a 3 log reduction or greater in a concentration of at least one of Staphylococcus aureus and Pseudamonas aeruginosa, under Modified JIS Z 2801 for Bacteria testing conditions.

According to a fiftieth aspect of the present disclosure, the polymeric material of any one of the fortieth through forty-sixth aspects is presented, wherein after 7 days of accelerated aging at 65° C. and 65% relative humidity, the polymeric material exhibits a 5 log reduction or greater in a concentration of at least one of Staphylococcus aureus and Pseudamonas aeruginosa, under Modified JIS Z 2801 for Bacteria testing conditions.

### BRIEF DESCRIPTION OF THE DRAWINGS

In the figures:

FIG. 1 is a perspective view of a length of a multi-component filament, illustrating a first component radially surrounding a second component;

FIG. 2 is a perspective view of a multi-component filament like FIG. 1, but this time illustrating three “stripes” of the second component forming part of a surface of the multi-component filament and the first component forming the remainder of the surface;

FIG. 3 is a perspective view of a multi-component filament like FIG. 1, but this time illustrating the second component radially surrounding the first component and thus providing the entirety of the surface of the multi-component filament;

FIG. 4 is a cross-sectional view of the multi-component filament taken along line IV-IV of FIG. 1, illustrating the second component having a polymer matrix, copper-containing particles dispersed throughout the polymer matrix, and the multi-component filament having a first state where copper-containing ions (e.g., Cu¹⁺ ions) have not yet migrated from the polymer matrix of the second component into the first component;

FIG. 5 is the same view as FIG. 4, but this time illustrating the multi-component filament having a second state where copper-containing ions (e.g., Cu¹⁺ ions) have migrated from the polymer matrix of the second component, into the first component, and to the surface of the multi-component filament provided by the first component;

FIG. 6 is a scanning electron microscopy (SEM) image of a cross-section of a glass-ceramic from which embodiments of the copper-containing particles present in the second component of the multi-component filament are made, illustrating that glass-ceramic has a first glass phase, a second glass phase, and cuprite crystals (providing Cu¹⁺ ions) dispersed primarily in the second glass phase;

FIG. 7 is a flow chart of a method of manufacturing the multi-component filament of the previous figures;

FIG. 8 pertains to Example 1 and illustrates, in graph form, measured antimicrobial log kill values for composites that can form the second component of the multi-component filament, highlighting that polyetherimide (“PEI”) can extract sufficient Cu¹⁺ ions from the copper-containing particles in the presence of the solvent, regardless of the solvent, and that N-methyl-2-pyrrolidone (“NMP”) as the solvent can extract sufficient Cu¹⁺ ions from the copper-containing particles, regardless of the polymer, to imbue the composite (including the polymer forming the polymer matrix) with antimicrobial efficacy;

FIG. 9A is a perspective view of an article with a polymeric material disposed over a substrate, illustrating the polymeric material including a polymer and ions of a copper nitrile complex dispersed throughout the polymer to imbue the polymeric material and thus the article with antimicrobial activity;

FIG. 9B is a perspective view of an article with a polymeric material disposed over a substrate, illustrating the polymeric material including a polymer, copper-containing particles dispersed throughout the polymer, and copper-containing ions dispersed throughout the polymer to imbue the polymeric material and thus the article with antimicrobial activity;

FIG. 10, pertaining to Examples 2A-2F, is a graph that illustrates antimicrobial efficacy of polymeric materials of the present disclosure, both as-made and after four months from formation; and

FIG. 11, also pertaining to Examples 2A-2F, is a graph that illustrates antimicrobial efficacy of polymeric materials of the present disclosure, (i) at room temperature, (ii) after accelerated aging for one day, and (iii) after accelerated aging for seven days.

### DETAILED DESCRIPTION

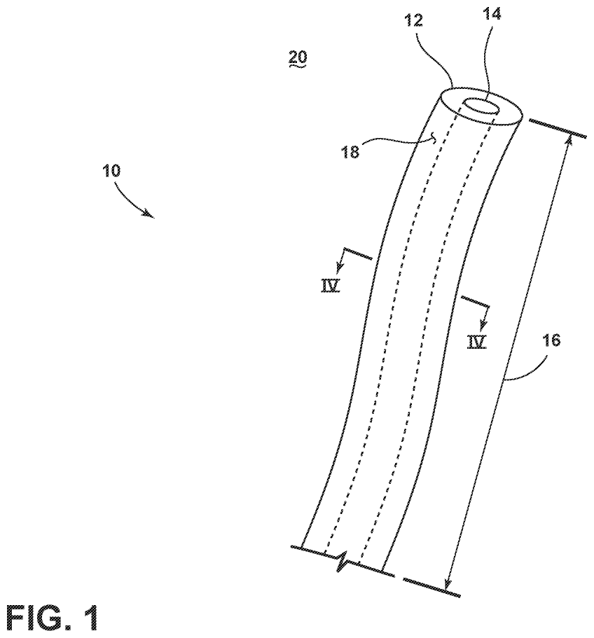

Referring now to FIGS. 1-5, a multi-component filament 10 includes a first component 12 and a second component 14. The first component 12 extends longitudinally along a length 16 of the multi-component filament 10. The second component 14 extends longitudinally along the length 16 of the multi-component filament 10, as well.

The multi-component filament 10 has a surface 18 that faces an environment 20 external to the multi-component filament 10. In embodiments, such as that illustrated in FIG. 1, only the first component 12 provides the surface 18 of the multi-component filament 10.

In embodiments, such as that illustrated in FIG. 1, the first component 12 radially surrounds the second component 14 throughout the length 16 of the multi-component filament 10. In such embodiments, the first component 12 may be thought to form a sheath or dad around a core formed by the second component 14.

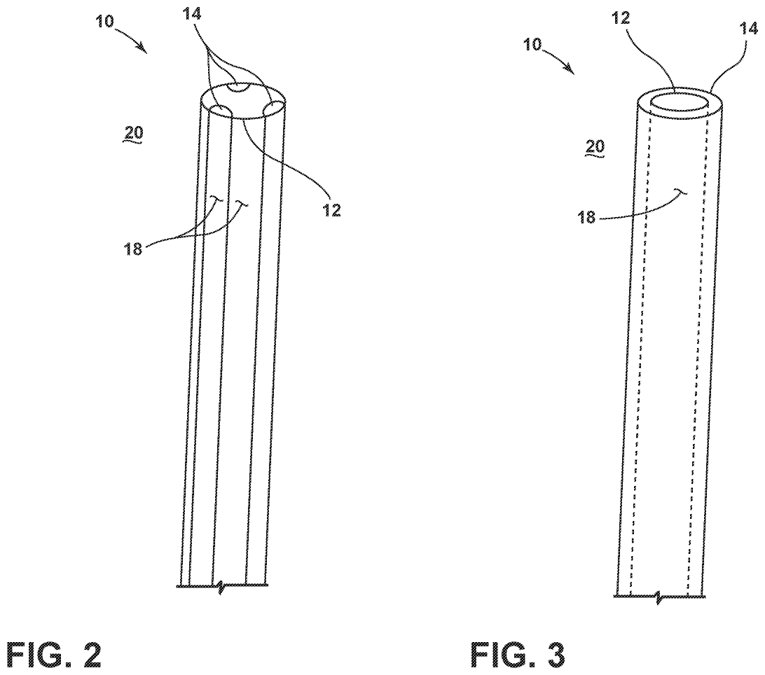

In embodiments, such as that illustrated at FIG. 2, both the first component 12 and the second component 14 provide portions of the surface 18 of the multi-component filament 10. The illustration of the multi-component filament 10 of FIG. 2 shows three “stripes” of the second component 14. However, the multi-component filament 10 can include any number of “stripes” of the second component 14 (e.g., 1, 2, 3, 4, or more “stripes”) when the second component 14 provides a portion of the surface 18 of the multi-component filament 10.

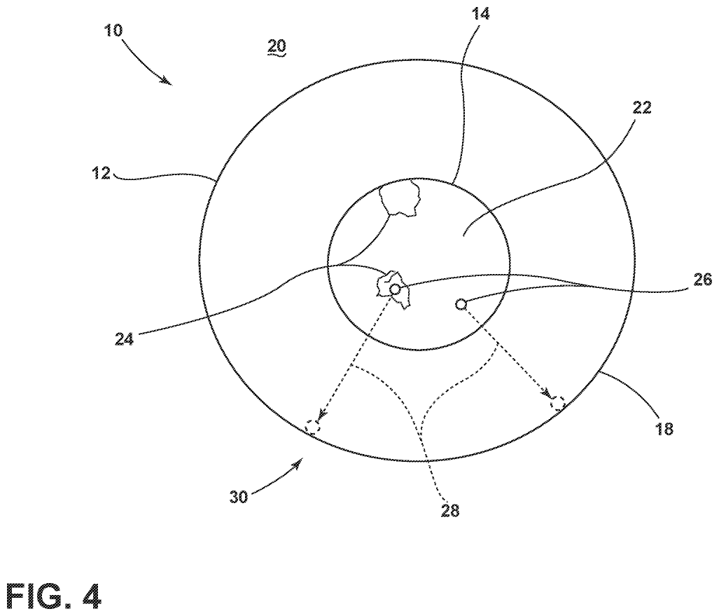

In embodiments, only the second component 14 provides the surface 18. In embodiments, such as that illustrated at FIG. 3, the second component 14 radially surrounds the first component 12 throughout the length 16 of the multi-component filament 10. In such embodiments, the second component 14 may be thought to form a sheath or clad around a core formed by the first component 12.

The first component 12 includes a first polymer. In embodiments, the first polymer of the first component 12 includes a nylon. In embodiments, the first polymer of the first component 12 includes one or more of nylon 6 and nylon 66. In embodiments, the first polymer of the first component 12 includes nylon 6. In embodiments, the first polymer of the first component 12 includes nylon 66. In embodiments, the first polymer of the first component 12 includes one or more of a polyester, polybutylene terephthalate, polypropylene, and polyethylene. In embodiments, the first polymer of the first component 12 includes polyethylene. The first polymer of the first component 12 is not limited to these specifically listed polymers.

The second component 14 is a composite that includes (i) a second polymer 22, (ii) copper-containing particles 24 dispersed throughout the second polymer 22, and (iii) a plurality of copper-containing ions 26 disposed throughout the second polymer 22. In embodiments, the second component 14 includes the second polymer 22 and the copper-containing ions 26 but not the copper-containing particles 24. In embodiments, the second polymer 22 of the composite of the second component 14 includes a nitrogen with a lone pair of electrons. In embodiments, the second polymer 22 of the composite of the second component 14 includes one or more of polyethyleneimine, a nylon, an aramid precursor polymer, polyetherimide, a polyamide-imide, polystyrene, poly(methyl methacrylate), polyimide, melamine resin, urea-formaldehyde, polyacrylonitrile, a copolyimide, an amide-containing polymer, a pyrrole-containing polymer, and an indole-containing polymer. “An aramid precursor polymer” means a polymer from which an aramid fiber could be formed. In embodiments, the second polymer 22 includes a nylon. In embodiments, the second polymer 22 includes one or more of nylon 6 and nylon 66. In embodiments, the second polymer 22 includes nylon 6. In embodiments, the second polymer 22 includes nylon 66.

In embodiments, the second component 14 further includes an additive dispersed throughout the second polymer 22. In embodiments, the additive is one or more of 2-ethylhexylphosphate, imidazole, benzoxazole, benzimidazole, benzothiazole, benzopyrrole, phthalimide, urea, a nitrile, imidazole, a pyrrole, an indole, a maleimide, a succinimide, an organo-phosphate, an organo-phosphite, and an organo-phosphonate. In embodiments, the additive includes one or more of N-methyl-2-pyrrolidone, dimethylformamide, acetamide, formamide, 2-pyrrolidone, N-formylmorpholine, urea, β-propiolactam, δ-valerolactam, ε-caprolactam, acetonitrile, and benzonitrile. As will be further discussed below, either the second polymer 22 or the additive, or both the second polymer 22 and the additive, interact with the copper-containing particles 24 to extract copper-containing ions 26 (e.g., Cu⁺¹ ions) from the copper-containing particles 24. Further, the additive facilitates migration of the copper-containing ions 26 through the second polymer 22, even when the second component 14 lacks copper-containing particles 24 but was formed with copper-containing ions 26 dispersed throughout the second polymer 22.

The copper-containing ions 26 discussed herein can be Cu¹⁺ ions, Cu²⁺ ions, both Cu¹⁺ ions and Cu²⁺ ions, and/or ions of a copper nitrile complex. In embodiments, the ions of copper nitrile complex are [Cu(CH₃CN)₄], which is tetrakis(acetonitrile)copper(II) cation. Other ions of copper nitrile complex are suitable, including ions of a copper propionitrile complex, a copper benzonitrile complex, a copper p-anisonitrile complex, a copper p-nitrobenzonitrile complex, and a copper 1-naphthonitril complex. The ions of the copper nitrile complex can be dispersed throughout the second polymer 22 by dissolving both the second polymer 22 and a salt of the copper nitrile complex in one or more solvents. The one or more solvents then evaporate, the second polymer 22 with the ions of the copper nitrile complex dispersed throughout the second polymer 22.

In embodiments, both the second polymer 22 of the composite of the second component 14 and the first polymer of the first component 12 include such an additive. The additive dispersed throughout the second polymer 22 of the composite of the second component 14 and the additive dispersed throughout the first polymer of the first component 12 can be the same (e.g., both benzimidazole), or can be different (e.g., benzimidazole can be the additive of the second polymer 22 of the composite of the second component 14, while imidazole can be the additive of the first polymer of the first component 12). The additive extracts copper-containing ions 26 from the copper-containing particles 24 and/or helps migration of copper-containing ions 26, as further explained.

In embodiments, at least a portion of the copper-containing ions 26 is in a state of migration 28. In embodiments, such as at FIG. 1, where the first component 12 radially surrounds the second component 14, the state of migration 28 is generally from the second polymer 22 of the second component 14, into the first polymer of the first component 12, and then to the surface 18 of the multi-component filament 10. In addition, the state of migration 28 includes migration 28 of a portion of the copper-containing ions 26 from the copper-containing particles 24 dispersed throughout the second polymer 22 of the second component 14 into the second polymer 22 of the second component 14, and thereafter into the first polymer of the first component 12 and to the surface 18 of the multi-component filament 10.

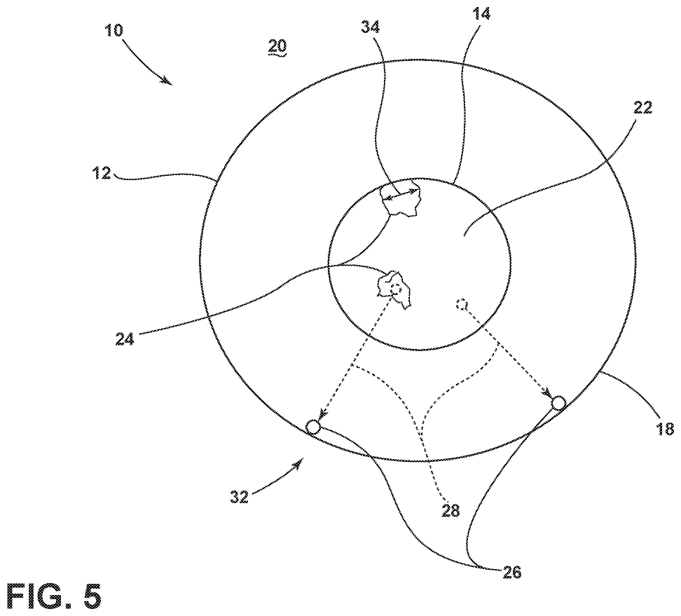

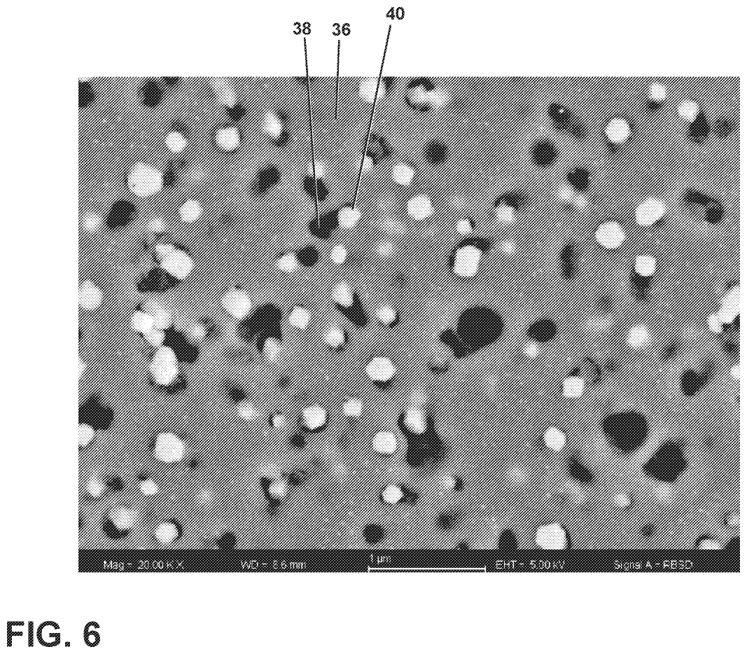

In embodiments, the multi-component filament 10 transitions from a first state 30 (FIG. 4) to a second state 32 (FIG. 5). In the first state 30 (FIG. 4), the surface 18 of the multi-component filament 10 is substantially free of copper-containing ions 26. In embodiments, the multi-component filament 10 is in the first state 30 contemporaneously upon formation of the multi-component filament 10 and for a period of time thereafter. The second state 32 occurs after the first state 30. In the second state 32, a portion of the copper-containing ions 26 is disposed at the surface 18 of the multi-component filament 10. In a period of time between the first state 30 and the second state 32, the portion of the copper-containing ions 26 migrates 28 from the first component 12 into the second component 14 and then to the surface 18 of the multi-component filament 10.

As mentioned, the second polymer 22 can include a nitrogen with a lone pair of electrons. If the second polymer 22 is aminated (e.g., has an amine group), such as polyethyleneimine, then the second polymer 22 will likely bond to copper-containing ions 26 in the copper-containing particles 24, and thereby extract copper-containing ions 26 from the copper-containing particles 24. Polymers with an amide or imide group, such as a nylon, polyetherimide, and polyamide imide, also are able to extract copper-containing ions 26 from the copper-containing particles 24. Conversely, polymers without an amine, amide, or imide functional group (e.g., lacking a nitrogen with a lone pair of electrons), such as poly(methyl methacrylate), polystyrene, polyvinyl chloride, and polyethylene, would (alone) have little or no ability to extract copper-containing ions 26 from the copper-containing particles 24. In embodiments, the first polymer of the first component 12 includes a nitrogen with a lone pair of electrons.

The additive included in the first component 12 and/or in the second polymer 22 of the second component 14 can include a nitrogen with a lone pair of electrons or some other functional group that interact with copper-containing ions 26 and extract copper-containing ions 26 from the copper-containing particles 24. In other words, even if the second polymer 22 alone is unable to efficiently extract copper-containing ions 26 from the copper-containing particles 24, the additive can be chosen to extract copper-containing ions 26 from the copper-containing particles 24 instead. In embodiments, both the additive and the second polymer 22 include a nitrogen with a lone pair of electrons. In embodiments, all of the additive, the second polymer 22, and the first polymer of the first component 12 include a nitrogen with a lone pair of electrons.

The additive included in the first component 12 and/or in the second polymer 22 of the second component 14 facilitates the migration 28 of the copper-containing ions 26 through wherever the additive is located and to the surface 18 of the multi-component filament 10. Without being bound by theory, it is believed that the additives mentioned above include ligands that bond to copper-containing ions 26 in the polymer of the first component 12 or the second polymer 22 of the second component 14, as the case may be, forming a copper ion-ligand complex. While the ligands of the additive are bound to the copper-containing ions 26, the ionic state of the copper ion (e.g., as Cu¹⁺ ion) remains stable (e.g., does not easily change to Cu²⁺ ion). For example, the nitrile group of acetonitrile is a ligand and favors the Cu¹⁺ ion state. In addition, the surface energy of the copper ion-ligand complex favors migration 28 of the copper ion-ligand complex to the surface 18 of the multi-component filament 10. The more copper-containing ions 26 that migrate 28 to the surface 18 of the multi-component filament 10, the greater and longer lasting the antimicrobial activity of the multi-component filament 10.

Further, polymers with an amide or imide group, such as a nylon, polyetherimide, and polyamide imide, if included into the first component 12 (e.g., as the first polymer) and/or the second component 14 (e.g., as the second polymer 22), stabilize the copper-containing ions 26 while the copper-containing ions 26 migrate 28 through the first polymer of the first component 12 and/or the second polymer 22 of the second component 14. By “stabilize the copper-containing ions 26,” it is meant that the if copper-containing ions 26 are extracted from the copper-containing particles 24 in a Cu¹⁺ state, then the polymer maintains the copper-containing ions 26 in that Cu¹⁺ state while migrating to the surface 18 of the multi-component filament 10.

In embodiments, both the additive and the second polymer 22 of the second component 14 are able to extract copper-containing ions 26 from the copper-containing particles 24 of the second component 14, and the second polymer 22 has an amide or imide group, such as a nylon, polyetherimide, and polyamide imide. In such embodiments, although the second polymer 22 has less ability to extract copper-containing ions 26 than an aminated polymer (e.g., a polymer with an amine group), the second polymer 22 with an amide or imide group provides stability to the extracted copper-containing ions 26, including while the copper-containing ions 26 migrate 28 through the second polymer 22 of the composite of the second component 14 of the multi-component filament 10.

The copper-containing particles 24 still comprise copper-containing ions 26 despite the additive and/or the second polymer 22 extracting a portion of copper-containing ions 26 therefrom. The copper-containing particles 24 therefore, in embodiments, act as a reservoir of copper-containing ions to be later extracted and migrated to the surface 18. In other words, either the second polymer 22 of the composite of the second component 14 and/or the additive dispersed throughout the second polymer 22 of the composite of the second component 14 continue to extract copper-containing ions 26 from the copper-containing particles 24. The additive assists in migrating the copper-containing ions 26 so extracted through the second polymer 22 of the composite of the second component 14 and to the surface 18 of the multi-component filament 10 that the second component 14 provides, if the second component 14 provides a portion of the surface 18, or into the first component 12.

Thereafter, the first polymer of the first component 12, or an additive in the first component 12, assists in migrating the copper-containing ions 26 to the surface 18 of the multi-component filament 10 that the first component 12 provides. The copper-containing ions 26 at the surface 18 interact with and kill microbes, exhausting those copper-containing ions 26.

The extraction and migration 28 process continues to replenish the surface 18 with new copper-containing ions 26 from the copper-containing particles 24 dispersed throughout the second polymer 22 of the second component 14.

Each of the copper-containing particles 24 has a diameter 34, which is the largest dimension of the copper-containing particle 24. In embodiments, the median diameter (D50) of the copper-containing particles 24 is within a range of 1 μm to 5 μm. In embodiments, the median diameter of the copper-containing particles 24 is 1 μm, 2 μm, 3 μm, 4 μm, 5 μm, 6 μm, 7 μm, 8 μm, 9 μm, 10 μm, or within any range defined by any two of those values (e.g., 2 μm to 5 μm, 3 μm to 8 μm, and so on). The copper-containing particles 24 may be substantially spherical or may have an irregular shape.

In embodiments, the copper-containing particles 24 include one or more of glass, a glass-ceramic, cuprite crystals, metallic copper, copper oxide, and a copper salt. In embodiments, the copper-containing particles 24 include metallic copper. In embodiments, the copper-containing particles 24, when including a glass or glass-ceramic, are substantially free of tenorite. Example copper salts include copper halide, copper(I) acetate, and copper sulfate. In addition, the copper salt can be a salt of a copper nitrile complex, such as tetrakis(acetonitrile)copper(I) hexafluorophosphate.

In embodiments, the composite forming the second component 14 includes the copper-containing particles 24 within a range of 1 wt % to 20 wt %. In other words, the copper-containing particles 24, in those embodiments, are 1 wt % to 20 wt % of the composite forming the second component 14. In embodiments, the copper-containing particles 24 are 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt % of the composite forming the second component 14, or within any range defined by any two of those values (e.g., 4 wt % to 15 wt %, 6 wt % to 19 wt %, and so on). In other embodiments, the copper-containing particles 24 are less than 1 wt % or greater than 20 wt % of the composite forming the second component 14.

In embodiments, the second component 14 is 1% to 30% of a cross-sectional area of the multi-component filament 10, with the first component 12 making up a remainder of the cross-sectional area of the multi-component filament 10. A cross-sectional area is for example as illustrated at FIGS. 4 and 5, with the surface 18 facing the environment 20 external forming a perimeter of the cross-sectional area. In embodiments, the second component 14 is 1%, 5%, 10%, 15%, 20%, 25%, or 30% of the cross-sectional area of the multi-component filament 10, or is a percentage within any range bound by any two of those values (e.g., from 1% to 20%, from 10% to 30%, and so on) of the cross-sectional area of the multi-component filament 10. In other instances, the second component 14 is greater than 30% of the cross-sectional area of the multi-component filament 10.

In embodiments, the copper-containing particles 24 include glass or glass-ceramic. In some of such embodiments where the copper-containing particles 24 include glass or glass-ceramic, at least a portion of the copper-containing ions 26 is part of a glass network of the glass or glass-ceramic. In some embodiments, where the copper-containing particles 24 include glass-ceramic, at least a portion of the plurality of copper-containing ions 26 in the copper-containing particles 24 is present in the glass-ceramic as cuprite crystals.

In embodiments where the copper-containing particles 24 include glass or glass-ceramic, the glass or glass-ceramic includes SiO₂ and a greater than 0 mol % of one or more of Al₂O₃, B₂O₃, P₂O₅, and R₂O (where R₂O is one or more of Li₂O, Na₂O, K₂O, Rb₂O and/or Cs₂O).

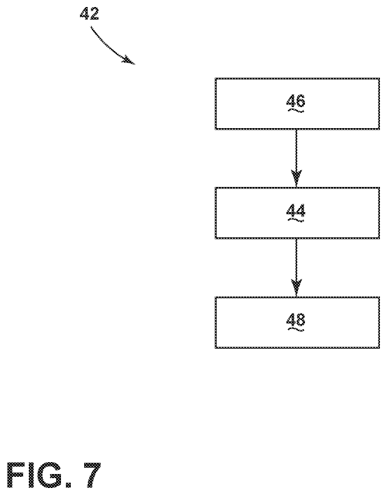

In embodiments, in reference to FIG. 6, the glass or glass-ceramic includes (i) a first glass phase 36 comprising SiO₂, and (ii) a second glass phase 38 including one or more of B₂O₃, P₂O₅, and R₂O, where R is one or more of K, Na, Li Rb, and Cs. At least a portion of the plurality of copper-containing ions 26 in the copper-containing particles 24 is disposed in one or more of the first glass phase 36 or the second glass phase 38. In embodiments, the second glass phase 38 is leachable, meaning that the second glass phase 38 (including copper-containing ions 26 disposed in the second glass phase 38) leaches in the presence of water. In embodiments, the glass-ceramic includes cuprite crystals 40 in both the first glass phase 36 and the second glass phase 38, or in just the second glass phase 38. Copper-containing ions 26 can also be present in the glass matrix of the glass portion of the glass-ceramic.

In embodiments where the copper-containing particles 24 include glass or glass-ceramic, the copper-containing particles 24, in embodiments, include Cu⁰ and Cu²⁺ ions, in addition to Cu¹⁺ ions. In embodiments, the copper-containing particles 24 comprise a greater percentage of Cu¹⁺ ions and Cu⁰ than Cu²⁺ ions. The relative amounts of Cu¹⁺, Cu²⁺ and Cu⁰ may be determined using x-ray photoluminescence spectroscopy (XPS) techniques known in the art. In embodiments, the total amount of all copper forms in the glass or glass-ceramic is (in wt %) 10, 11, 12, 13, 14, 15, 16, 17, 18, 19, 20, 21, 22, 23, 24, 25, 26, 27, 28, 29, 30, or within any range defined by any two of those values (15 to 30, 10 to 25, and so on).

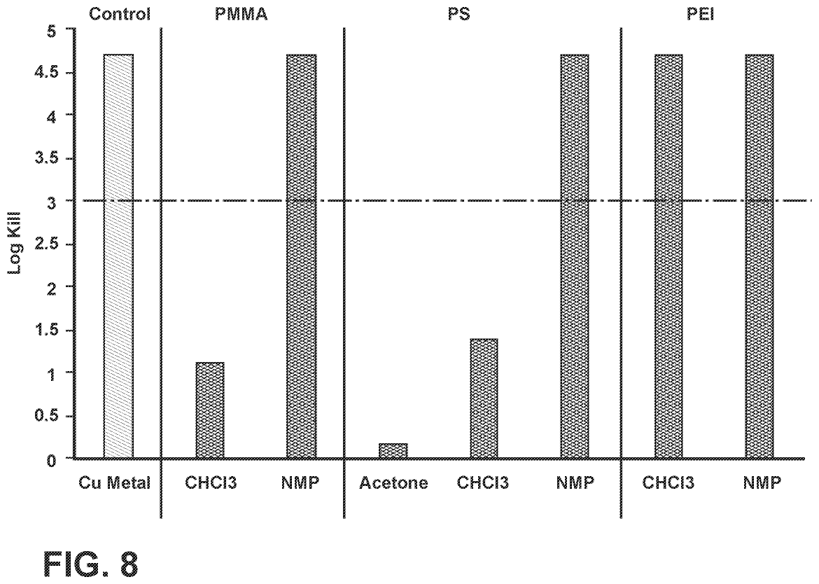

Referring now to FIG. 7, a method 42 of manufacturing the multi-component filament 10 is herein described. At a step 44, the method 42 includes coextruding (A) a first molten stock including the first polymer, which will form the first component 12 of the multi-component filament 10 and (B) the composite including the second polymer 22 in a molten state, along with the copper-containing particles 24 (or along with the copper-containing ions 26, if the second polymer 22 has the copper-containing ions 26 dispersed therein). In embodiments, either the second polymer or an additive dispersed throughout the second polymer, or both, comprise a nitrogen with a lone pair of electrons. As discussed above, the nitrogen with the lone pair of electrons facilitates the extraction of copper-containing ions 26 from the copper-containing particles 24 into the second polymer 22 and the migration 28 of the copper-containing ions 26 to the surface 18 of the multi-component filament 10.

The copper-containing particles 24 are not molten but flow with the second polymer 22 during the co-extrusion, while the second polymer 22 is in the molten state. The co-extrusion of the first molten stock of the first polymer and the composite with the second polymer 22 in the molten state forms the multi-component filament 10 with the first component 12 (from the first molten stock) and the second component 14 (from the composite). This step of co-extrusion may be referred to as co-spinning or bi-component spinning. The co-extrusion is performed with spinnerets, which are configured to coextrude the first molten stock of the first polymer and the second polymer 22 of the composite in a molten state in the desired spatial relationship (e.g., FIG. 1 versus FIG. 2 versus FIG. 3), as a combined melt stream. Other spatial relationships than those specifically illustrated in FIGS. 1-3 are possible. The combined melt stream is then quenched or otherwise solidified, forming the multi-component filament 10. The first component 12 provides melt strength to the multi-component filament 10. The melt strength is sufficient to result in high yield spinning (co-extrusion) of the multi-component filament 10. The multi-component filament 10 can be stretched during this co-extrusion/spinning step. The resulting multi-component filament 10 is gathered onto one or more bobbins.

In embodiments, the first component 12 further includes a colorant. The colorant can be added to the first molten stock before co-extrusion with the composite including the second polymer 22 in the molten state.

In embodiments, at a step 46, the method 42 further includes forming the copper-containing particles 24. In embodiments, forming the copper-containing particles 24 comprises: (i) forming glass or glass-ceramic by melting a batch comprising (on an oxide basis, in mol %):
SiO₂: 40 to 70;
a copper-containing oxide(s): 17.5 to 40; and
greater than 0 mol % of one or more of Al₂O₃, B₂O₃, P₂O₅, and R₂O (where R₂O is one or more of Li₂O, Na₂O, K₂O, Rb₂O and/or Cs₂O), and
(ii) segmenting the glass or glass-ceramic into the copper-containing particles 24. The copper-containing oxide can be one or more of CuO and Cu₂O. In embodiments, if the batch includes Al₂O₃, then the mole percentage of CuO in the batch is greater than the mole percentage of Al₂O₃ in the batch. Particular examples of such a batch include those in Table 1 below, in mole percentage.

TABLE 1

| Example | 12 | 13 | 14 | 25 | 28 | | |
|---|---|---|---|---|---|---|---|
| SiO₂ | 60 | 60 | 50 | 60 | 50 | | |
| Al₂O₃ | 5 | | | 5 | 5 | | |
| CuO | 20 | 20 | 20 | 20 | 20 | | |
| Na₂O | | | | 10 | 10 | | |
| K₂O | 10 | 10 | 10 | | | | |
| B₂O₃ | | 5 | 10 | | 10 | | |
| P₂O₅ | 5 | 5 | 10 | 5 | 5 | | |
| Melt Temp | 1650 | 1650 | 1650 | 1650 | 1650 | | |
| (° C.) | | | | | | | |
| Melt Time | overnight | overnight | overnight | overnight | overnight | | |
| Anneal | 700 | 600 | 600 | 650 | 650 | | |
| Temp (° C.) | | | | | | | |
| Efficacy | >log 4 | >log 3 | >log 6 | >log 4 | >log 3 | | |
| (S. aureus) | | | | | | | |
| Total Cu | 20.8 | 20.8 | 20.5 | 21.5 | 21.4 | | |
| (wt %) | | | | | | | |
| Cu¹⁺/total Cu | 0.85 | 0.77 | 0.85 | 0.85 | 0.82 | | |
| Example | 29 | 30 | 31 | 43 | 44 | 56 | 58 |
| SiO₂ | 50 | 55 | 55 | 48 | 48 | 45 | 50 |
| Al₂O₃ | 5 | | | 0 | 0 | | |
| CuO | 20 | 20 | 20 | 30 | 30 | 35 | 35 |
| Na₂O | | | 10 | 0 | 0 | | |
| K₂O | 10 | 10 | | 8.8 | 8.8 | 7.5 | 10 |
| B₂O₃ | 10 | 10 | 10 | 8.8 | 8.8 | 7.5 | |
| P₂O₅ | 5 | 5 | 5 | 4.4 | 4.4 | 5 | 5 |
| Melt Temp | 1650 | 1650 | 1650 | 1650 | 1650 | | |
| (° C.) | | | | | | | |
| Melt Time | overnight | overnight | overnight | overnight | overnight | | |
| Anneal | 650 | 650 | 650 | 650 | none | | |
| Temp (° C.) | | | | | | | |
| Efficacy | >log 3 | >log 4 | >log 3 | >log 6 | log 5.93 | log 6.151 | log 6.151 |
| (S. aureus) | | | | | | | |
| Total Cu | 22.2 | 21.6 | 22.4 | | | | |
| (wt %) | | | | | | | |
| Cu¹⁺/total Cu | 0.89 | 0.86 | 0.86 | 0.88 | | | |

In all of the examples 12-14, the resulting glass or glass-ceramic includes cuprite crystals 40, and a greater percentage of combined Cu¹⁺ and Cu⁰ than Cu²⁺. In all of the examples 25, 28-31, 43, 44, and 56, the resulting glass or glass-ceramic includes cuprite crystals 40. The total Cu (wt %) and the ratio of Cu¹⁺ to total Cu were determined by inductively coupled plasma techniques known in the art. The log reduction of Staphylococcus aureus of the glass or glass-ceramic was determined under the EPA Test Method for Efficacy of Copper Alloy as a Sanitizer testing conditions, and was tested by forming coupons of the glass or glass-ceramic having dimensions of 2.5 cm by 2.5 cm.

In embodiments where the copper-containing particles 24 include glass or glass-ceramic, SiO₂ serves as the primary glass-forming oxide. The batch can include SiO₂ in an amount (in mol %) of 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, or within any range defined by any two of those values (e.g., 40 to 65, 45 to 53, and so on).

In embodiments where the copper-containing particles 24 include glass or glass-ceramic, the included copper-containing oxide(s) forms the copper-containing ions 26 in the copper-containing particles 24. The batch can include copper-containing oxide(s) in an amount (in mol %) of 10, 11, 12, 13, 14, 15, 16, 17, 17.5, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, or within any range defined by any two of those values (e.g., 17.5 to 40, 20 to 35, and so on).

In embodiments where the copper-containing particles 24 include glass or glass-ceramic, Al₂O₃ may be included to serve as a glass-forming oxide and/or to control the viscosity of the molten batch. The batch can include Al₂O₃ in an amount (in mol %) of 5, 6, 7, 8, 9, 10, 11, 12, 13, 14, 15, 16, 17, 18, 19, 20, 21, 22, 23, 24, 25, or within any range defined by any two of those values (e.g., 5 to 20, 15 to 25, and so on). In embodiments, the batch (and thus the glass or glass-ceramic) is substantially free of Al₂O₃. In embodiments, the mole percentage of copper-containing oxide(s) in the batch is greater than the mole percentage of Al₂O₃ in the batch, which is believed to promote the formation of cuprite crystals 40 (Cu¹⁺ ions 26) instead of tenorite (Cu²⁺ ions, which are less antimicrobial than Cu¹⁺ ions 26).

In embodiments where the copper-containing particles 24 include glass or glass-ceramic, P₂O₅ may be included to induce formation of the second glass phase 38 of the glass or glass-ceramic. The batch can include P₂O₅ in an amount (in mol %) of 4, 4.1, 4.2, 4.3, 4.4, 4.5, 4.6, 4.7, 4.8, 4.9, 5, 6, 7, 8, 9, 10, 11, 12, 13, 14, 15, 16, 17, 18, 19, 20, or within any range defined by any two of those values (e.g., 4.4 to 20, 4 to 15, and so on). In embodiments, the batch (and thus the glass or glass-ceramic) is substantially free of P₂O₅.

In embodiments where the copper-containing particles 24 include glass or glass-ceramic, B₂O₃ may be included to induce formation of the second glass phase 38 of the glass or glass-ceramic. The batch can include B₂O₃ in an amount (in mol %) of 3, 4, 5, 6, 7, 8, 9, 10, 11, 12, 13, 14, 15, 16, 17, 18, 19, 20, or within any range defined by any two of those values (e.g., 5 to 10, 4 to 17, and so on). In embodiments, the batch (and thus the glass or glass-ceramic) is substantially free of B₂O₃.

In embodiments where the copper-containing particles 24 include glass or glass-ceramic, one or more alkali oxides (R₂O, e.g., one or more of Li₂O, Na₂O, K₂O, Rb₂O and/or Cs₂O) may be included in the batch to modify (e.g., lower) the melting temperature of the batch. In addition, K₂O specifically may be included to induce formation of the second glass phase 38 of the glass or glass-ceramic. The batch can include R₂O in an amount (in mol %) of 1, 2, 3, 4, 5, 6, 7, 8, 9, 10, 11, 12, 13, 14, 15, 16, 17, 18, 19, 20, or within any range defined by any two of those values (e.g., 5 to 15, 4 to 18, and so on). In embodiments, the batch (and thus the glass or glass-ceramic) is substantially free of R₂O.

In embodiments where the copper-containing particles 24 include glass or glass-ceramic, the batch can include one or more divalent cation oxides, such as alkaline earth oxides and/or ZnO, which can improve the melting behavior of the batch. For example, the batch can include ZnO in an amount (in mol %) of 1, 2, 3, 4, 5, 6, 7, 8, 9, 10, 11, 12, 12.5, 13, 14, 15, or within any range defined by any two of those values (e.g., 5 to 12.5, 4 to 10, and so on). In embodiments, the batch (and thus the glass or glass-ceramic) is substantially free of divalent cation oxides, including ZnO.

As mentioned above, the copper-containing ions 26 may form part of the glass network of the glass or glass-ceramic. Without being bound by theory, where copper-containing ions 26 are part of the glass network, it is believed that during typical glass formation processes, the cooling step of the molten glass occurs too rapidly to allow crystallization of the copper-containing oxide (e.g., CuO and/or Cu₂O). Thus, the copper-containing ions 26 remain in an amorphous state and become part of the glass network.

As mentioned above, the glass or glass-ceramic can include the first glass phase 36 and the second glass phase 38. In embodiments, phase separation occurs without any additional heat treatment of the glass or glass-ceramic. In some embodiments, phase separation may occur during melting of the batch and may be present when the batch is melted at temperatures up to and including about 1600° C. or 1650° C. When the batch is cooled, the phase separation is maintained during formation of glass or glass-ceramic. In embodiments where cuprite crystals 40 form, the cuprite crystals 40 can form in either the first glass phase 36 or the second glass phase 38, or, in embodiments, primarily in the second glass phase 38. A subsequent heat treatment of the glass or glass-ceramic can increase the size of the cuprite crystals 40 (e.g., “ripen” the microstructure of the several phases).

In embodiments, segmenting the glass or glass-ceramic into the copper-containing particles 24 includes grinding the glass or glass-ceramic into particles.

In embodiments, at a step 48, the method 42 further includes forming a textile comprising the multi-component filament 10. The textile will exhibit antimicrobial activity because of the copper-containing ions 26 at or near the surface 18 of the multi-component filaments 10 from which the textile was formed. The textile has a variety of applications, including within vehicles and architectural interiors (e.g., furniture, walls, carpeting, flooring).

In embodiments, a yarn is formed from a plurality of the multi-component filaments 10 (e.g., 25 to 100 multi-component filaments 10), and the textile is formed from a plurality of the yarns. The plurality of yarns may be weaved or knitted together to form the textile.

In embodiments such as illustrated in FIGS. 2 and 3, where the second component 14 of the multi-component filament 10 forms a portion (FIG. 2) or all (FIG. 3) of the surface 18 of the multi-component filament 10, the second component 14 directly provides antimicrobial activity because the copper-containing ions 26 are dispersed throughout the second polymer 22 of the second component 14 and thus are available at the surface 18. In addition, at least a portion of the copper-containing particles 24 is likely to form part of the surface 18 of the multi-component filament 10. Thus, copper-containing ions 26 are available to provide antimicrobial activity directly from the copper-containing particles 24.

In embodiments, such as that illustrated in FIG. 1, where only the first component 12 provides the surface 18 of the multi-component filament 10, the multi-component filament 10 provides antimicrobial activity after the multi-component filament 10 transitions from the first state 30 (FIG. 4) to the second state 32 (FIG. 5) and copper-containing ions 26 have migrated 28 from the first component 12 to the surface 18 that the second component 14 provides. Such embodiments are beneficial where the visible color of the multi-component filament 10 and resulting textile formed therefrom are important. The copper-containing particles 24, if included, likely have a color, such as orange or green. If the copper-containing particles 24 are disposed at the surface 18 of the multi-component filament 10 or otherwise visible, such as when the second component 14 provides a portion of the surface 18 of the multi-component filament 10, then the visible color of the multi-component filament 10 will likely be orange or green as well. However, co-extruding the first component 12 radially around the second component 14, and thus the copper-containing particles 24 within the second component 14, will reduce or nullify the impact that the color of the copper-containing particles 24 has on the visible color of the multi-component filament 10. Instead, the color of the first component 12 becomes the primary driver of the visible color of the multi-component filament 10. Although the copper-containing particles 24 remain “hidden” in the second component 14 below the first component 12, the additives migrate 28 the copper-containing ions 26 from the second component 14, through the first component 12, and to the surface 18 of the multi-component filament 10.

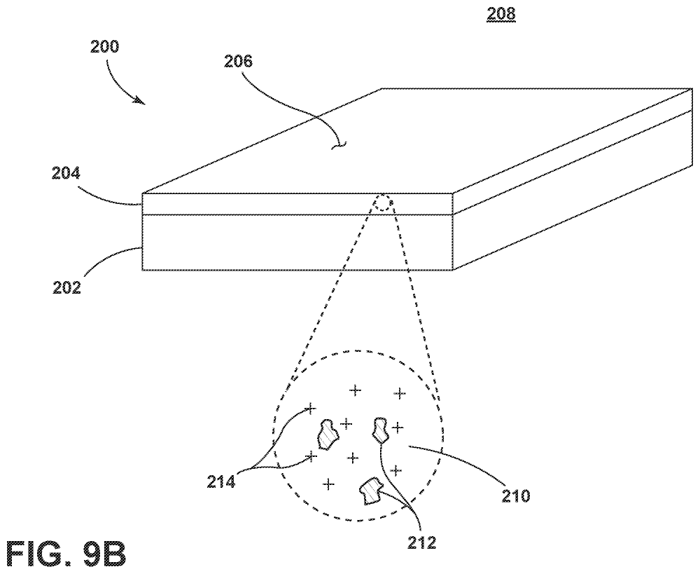

Referring now to FIG. 9A, an article 100 is illustrated including a substrate 102 and a polymeric material 104 disposed over the substrate 102. In embodiments, the polymeric material 104 is a coating over the substrate 102. In embodiments, the polymeric material 104 provides a surface 106 that is open to the environment 108 external to the article 100. The substrate 102 can have any composition.

The polymeric material 104 includes a polymer 110 and ions of a copper nitrile complex 112 dispersed throughout the polymer 110. The polymer 110 can have any composition, including those described above for the first polymer of first component 12 or the second polymer 22 of the second component 14 of the multi-component filament 10. In embodiments, the polymer 110 of the polymeric material 104 is one or more of a nylon, polyvinyl chloride, a polyester, polybutylene terephthalate, polypropylene, polyethylene, polyethyleneimine, an aramid precursor polymer, polyetherimide, a polyamide-imide, polystyrene, poly(methyl methacrylate), polyimide, melamine resin, urea-formaldehyde, polyacrylonitrile, a copolyimide, an amine-containing polymer, an amide-containing polymer, an imide-containing polymer, a pyrrole-containing polymer, and an indole-containing polymer. In embodiments, the polymer 110 is one or more of an amine-containing polymer, an amide-containing polymer, and an imide-containing polymer.

In embodiments, the ions of copper nitrile complex 112 are [Cu(CH₃CN)₄]⁺, which is tetrakis(acetonitrile)copper(I) cation. Other ions of copper nitrile complex 112 are suitable, including ions of a copper propionitrile complex, a copper benzonitrile complex, a copper p-anisonitrile complex, a copper p-nitrobenzonitrile complex, and a copper 1-naphthonitril complex. The ions of the copper nitrile complex 112 can be dispersed throughout the polymer 110 by dissolving both the polymer 110 and a salt of the copper nitrile complex in one or more solvents and then evaporating the one or more solvents so that the polymer 110 with the ions of the copper nitrile complex 112 dispersed throughout the polymer 110 precipitates. As the Examples 2A-2F below illustrated, such polymeric material 104 with the ions of copper nitrile complex 112 exhibits highly effective antimicrobial activity, without the need to include the additive as described hereinto to facilitate extraction of copper-containing ions 26 from copper containing particles 24 within the polymeric material 104 and without the need for the polymer 110 of the polymeric material 104 to include a nitrogen with a lone pair of electrons. However, as mentioned, the polymer 110 of the polymeric material 104 can include such a nitrogen with a lone pair of electrons.

In embodiments, the polymeric material 104 further includes an additive dispersed throughout the polymer 110. The additive can be any of those discussed above for the multi-component filament 10. In embodiments, the additive includes a nitrogen with a lone pair of electrons. In embodiments, the additive is one or more of 2-ethylhexylphosphate, imidazole, benzoxazole, benzimidazole, benzothiazole, benzopyrrole, phthalimide, urea, a nitrile, imidazole, a pyrrole, an indole, a maleimide, a succinimide, an organo-phosphate, an organo-phosphite, and an organo-phosphonate. In embodiments, the additive is one or more of N-methyl-2-pyrrolidone, dimethylformamide, acetamide, formamide, 2-pyrrolidone, N-formylmorpholine, urea, β-propiolactam, δ-valerolactam, ε-caprolactam, acetonitrile, and benzonitrile. Although the inclusion of the additive is unnecessary for the polymeric material 104 to exhibit antimicrobial activity, the additive facilitates migration of the ions of the copper nitrile complex toward the surface 106 of the polymeric material 104 and, thus, enables the polymeric material 104 to exhibit antimicrobial activity for a longer period of time than if the polymer material lacked the additive. This concept is further illustrated in Examples 2A-2F below.

In embodiments, the polymeric material 104 exhibits a 3 log reduction or greater in a concentration of at least one of Staphylococcus aureus and Pseudamonas aeruginosa, under Modified JIS Z 2801 for Bacteria testing conditions. In embodiments, the polymeric material 104 exhibits a 4 log reduction or greater in a concentration of at least one of Staphylococcus aureus and Pseudamonas aeruginosa, under Modified JIS Z 2801 for Bacteria testing conditions. In embodiments, the polymeric material 104 exhibits a 5 log reduction or greater in a concentration of at least one of Staphylococcus aureus and Pseudamonas aeruginosa, under Modified JIS Z 2801 for Bacteria testing conditions.

In embodiments, after 7 days of accelerated aging at 65° C. and 65% relative humidity, the polymeric material 104 exhibits a 3 log reduction or greater in a concentration of at least one of Staphylococcus aureus and Pseudamonas aeruginosa, under Modified JIS Z 2801 for Bacteria testing conditions. In embodiments, after 7 days of accelerated aging at 65° C. and 65% relative humidity, the polymeric material 104 exhibits a 4 log reduction or greater in a concentration of at least one of Staphylococcus aureus and Pseudamonas aeruginosa, under Modified JIS Z 2801 for Bacteria testing conditions. In embodiments, after 7 days of accelerated aging at 65° C. and 65% relative humidity, the polymeric material 104 exhibits a 5 log reduction or greater in a concentration of at least one of Staphylococcus aureus and Pseudamonas aeruginosa, under Modified JIS Z 2801 for Bacteria testing conditions.

Referring now to FIG. 9B, an article 200 is illustrated including a substrate 202 and a polymeric material 204 disposed over the substrate 202. The substrate 202 can have any composition. In embodiments, the polymeric material 204 is a coating over the substrate 202. In embodiments, the polymeric material 204 provides a surface 206 that is open to the environment 208 external to the article 200.

The polymeric material 204 includes a polymer 210, copper-containing particles 212 dispersed throughout the polymer 210, copper-containing ions 214 dispersed throughout the polymer 210, and an additive dispersed throughout the polymer 210. The copper-containing ions 214 dispersed throughout the polymer 210 reflect that the polymer 210, the additive, or both the polymer 210 and the additive can be selected to extract the copper-containing ions 214 from the copper-containing particles 212 and result in the dispersal of the copper-containing ions 214 throughout the polymer 210.

The polymer 210 can have any composition, including those described above for the polymer 110 of the article 100, the first polymer of first component 12 of the multi-component filament 10, or the second polymer 22 of the second component 14 of the multi-component filament 10. In embodiments, the polymer 210 of the polymeric material 204 is one or more of a nylon, polyvinyl chloride, a polyester, polybutylene terephthalate, polypropylene, polyethylene, polyethyleneimine, an aramid precursor polymer, polyetherimide, a polyamide-imide, polystyrene, poly(methyl methacrylate), polyimide, melamine resin, urea-formaldehyde, polyacrylonitrile, a copolyimide, an amine-containing polymer, an amide-containing polymer, an imide-containing polymer, a pyrrole-containing polymer, and an indole-containing polymer. In embodiments, the polymer 210 is one or more of an amine-containing polymer, an amide-containing polymer, and an imide-containing polymer. As discussed above, when the polymer has the appropriate composition, the polymer 210 can extract copper-containing ions 214 from the copper-containing particles 212, such as when the polymer 210 includes nitrogen with a lone pair of electrons.

The copper-containing particles 212 are the same as the copper-containing particles 24 discussed above for the multi-component filament 10. In embodiments, the copper-containing particles 212 include one or more of a glass, a glass-ceramic, cuprite crystals, metallic copper, copper oxide, and a copper salt. In embodiments, the copper-containing particles 212 include a glass or glass-ceramic. In embodiments, the glass or glass-ceramic is 30 wt % to 50 wt % of the polymeric material 204. In embodiments, the copper salt of the copper-containing particles 212 is a salt of a copper nitrile complex, such as tetrakis(acetonitrile)copper(I) hexafluorophosphate. In embodiments, the copper salt is within a range of from 0.5 wt % to 5 wt % of the polymeric material 204.

In embodiments, the polymeric material 204 further includes an additive dispersed throughout the polymer 210. The additive can be any of those discussed above for the multi-component filament 10. In embodiments, the additive includes a nitrogen with a lone pair of electrons. In embodiments, the additive is one or more of 2-ethylhexylphosphate, imidazole, benzoxazole, benzimidazole, benzothiazole, benzopyrrole, phthalimide, urea, a nitrile, imidazole, a pyrrole, an indole, a maleimide, a succinimide, an organo-phosphate, an organo-phosphite, and an organo-phosphonate. In embodiments, the additive is one or more of N-methyl-2-pyrrolidone, dimethylformamide, acetamide, formamide, 2-pyrrolidone, N-formylmorpholine, urea, β-propiolactam, δ-valerolactam, ε-caprolactam, acetonitrile, and benzonitrile. Inclusion of the additive facilitates extraction of copper-containing ions 214 from the copper-containing particles 212 and migration of the copper-containing ions 214 toward the surface 206 of the polymeric material 204 and, thus, enables the polymeric material 204 to exhibit antimicrobial activity even when the polymer 210 lacks the ability to extract the copper-containing ions 214 from the copper-containing particles 212. This concept is further illustrated in Examples 2A-2F below.

In embodiments, the polymeric material 204 exhibits a 3 log reduction or greater in a concentration of at least one of Staphylococcus aureus and Pseudamonas aeruginosa, under Modified JIS Z 2801 for Bacteria testing conditions. In embodiments, the polymeric material 204 exhibits a 4 log reduction or greater in a concentration of at least one of Staphylococcus aureus and Pseudamonas aeruginosa, under Modified JIS Z 2801 for Bacteria testing conditions. In embodiments, the polymeric material 204 exhibits a 5 log reduction or greater in a concentration of at least one of Staphylococcus aureus and Pseudamonas aeruginosa, under Modified JIS Z 2801 for Bacteria testing conditions.

In embodiments, after 7 days of accelerated aging at 65° C. and 65% relative humidity, the polymeric material 204 exhibits a 3 log reduction or greater in a concentration of at least one of Staphylococcus aureus and Pseudamonas aeruginosa, under Modified JIS Z 2801 for Bacteria testing conditions. In embodiments, after 7 days of accelerated aging at 65° C. and 65% relative humidity, the polymeric material 204 exhibits a 4 log reduction or greater in a concentration of at least one of Staphylococcus aureus and Pseudamonas aeruginosa, under Modified JIS Z 2801 for Bacteria testing conditions. In embodiments, after 7 days of accelerated aging at 65° C. and 65% relative humidity, the polymeric material 204 exhibits a 5 log reduction or greater in a concentration of at least one of Staphylococcus aureus and Pseudamonas aeruginosa, under Modified JIS Z 2801 for Bacteria testing conditions.

### EXAMPLES

Example 1—For Example 1, the steps of (i) contacting a polymer with an additive (here, solvent), (ii) adding copper-containing particles to the additive with the polymer present, and (iii) forming a composite including the copper-containing particles dispersed throughout the polymer, were performed with various kinds of polymers and additives. More specifically, in reference to the Table 2 below, three different polymers (specifically polystyrene (“PS”), poly(methyl methacrylate) (“PMMA”), and polyetherimide (“PEI”)) were each contacted with three different additives (specifically, chloroform (“CHCl₃”), acetone, and N-methyl-2-pyrrolidone (“NMP”)). The polymer was 15 wt % of the combined polymer and additive.

TABLE 2

| | solvent | | |
|---|---|---|---|
| Polymer | chloroform | acetone | NMP |
| Polystyrene | − | − | + |
| poly(methyl methacrylate) | − | − | + |
| Polyetherimide | + | − | + |

After the polymers were contacted with the additives, copper-containing particles in the form of a glass or glass-ceramic were added, with the copper-containing particles being 5 wt % to 20 wt % of the combined polymer, additive, and copper-containing particles. The contents were mixed with a magnetic stirrer for 2 hours. After that, the contents were cast into a polytetrafluoroethylene dish and dried in an oven for about 16 hours at a temperature below the boiling point of the additive. A film of the composite remained, with the copper-containing particles dispersed throughout the polymer. The composite film was then cut into 1 inch by 1 inch coupons. The coupons were then tested for antimicrobial activity. The greater antimicrobial activity that the composite exhibited, the greater the ability of the polymer and/or the solvent to extract copper-containing ions (particularly Cu¹⁺ ions) from the copper-containing particles while the polymer was dissolved in solution and in contact with the copper-containing particles. The antimicrobial activity of copper metal was additionally tested, as an experimental control.

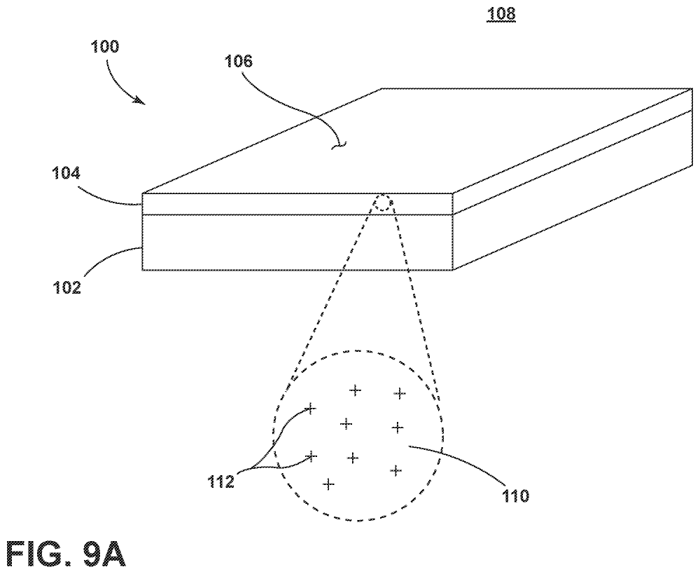

As the Table 2 above and the graph reproduced at FIG. 8 reveal, the composites formed from polystyrene (“PS”) and poly(methyl methacrylate) (“PMMA”) contacted with either chloroform (“CHCl₃”) or acetone exhibited little if any antimicrobial activity (denoted by “−” in Table 2). Those results confirm that neither of those polymers and neither of those additives extracted copper-containing ions from the copper-containing particles in the composite. In contrast, the composites formed from polystyrene (“PS”) and poly(methyl methacrylate) (“PMMA”) contacted with N-methyl-2-pyrrolidone (“NMP”) exhibited antimicrobial activity on par with the control of metallic copper (greater than 4.5 log kill) (denoted by “+” in Table 2). Those results confirm that, even with the polymer as a weak extractor of copper-containing ions, a correctly chosen additive, such as N-methyl-2-pyrrolidone (“NMP”), can extract well copper-containing ions from the copper-containing particles in the composite. The copper-containing ions that the additive extracted remain in the composite after the additive (here, as solvent) is removed.

The high antimicrobial activity of the composites including N-methyl-2-pyrrolidone (“NMP”) was surprising and unexpected, because N-methyl-2-pyrrolidone weakly interacts with copper-containing ions. It appears that nitrogen lone pairs are particularly suitable to interact with copper-containing ions (particularly Cu¹⁺ ions) in a manner that provides high antimicrobial activity. An explanation for the low antimicrobial activity resulting from chloroform as the additive is that chloroform does not have free lone pair electrons and therefore, has too weak of an interaction with copper-containing ions. An explanation for the low antimicrobial activity resulting from acetone as the additive is that although acetone does have free lone pair electrons, those lone pair electrons are not associated with nitrogen. Polyetherimide, the polymer tested providing the greatest antimicrobial activity regardless of additive, like N-methyl-2-pyrrolidone, has lone pair electrons associated with nitrogen. These lone pair electrons associated with nitrogen overlap with the d-orbitals of copper-containing ions (particularly Cu¹⁺ ions).

As a further comparison, the composites including the polymer polyetherimide (“PEI”) exhibited antimicrobial activity on par with the control of metallic copper (greater than 4.5 log kill), regardless of the additive that contacted the polymer. Those results confirm that the polymer alone can extract copper-containing ions from the copper-containing particles, even when the additive cannot alone extract a sufficient number of copper-containing ions for the composite to exhibit antimicrobial activity, such as when the polymer is chloroform (“CHCl₃”).

It is believed that the composites could be molten and co-extruded with another polymer into the multi-component filaments described herein, and that such multi-component filaments would exhibit antimicrobial activity.

Examples 2A-2E—For Examples 2A-2E, the antimicrobial activities of various polymeric materials of the present disclosure were evaluated and compared to other materials. To formulate the polymeric materials of all of the Examples 2A-2E, XL-8 Plastic Coating (from V.O. Baker Company) was utilized to provide the polymer (specifically, polyvinyl chloride) of the polymeric material. XL-8 Plastic Coating is about 33 wt % polyvinyl chloride dissolved in various solvents. Note that polyvinyl chloride is a polymer that lacks a functional group with a nitrogen having a lone pair of electrons.

For Example 2A, 0.25 g of copper-containing particles in the form of a glass or glass-ceramic of the present disclosure dispersed in methyl ethyl ketone was added to 6 g of the XL-8 Plastic Coating and stirred. The solvents were allowed to evaporate, leaving the copper-containing particles dispersed throughout the polyvinyl chloride.

For Example 2B, 0.25 g of copper-containing particles in the form of a glass or glass-ceramic of the present disclosure dispersed in methyl ethyl ketone was added to 6 g of the XL-8 Plastic Coating along with 0.21 g of 2-ethylhexyl phosphate as an additive. The solvents were allowed to evaporate, leaving the copper-containing particles and the 2-ethylhexyl phosphate dispersed throughout the polyvinyl chloride.

For Example 2C, 0.75 g of copper-containing particles in the form of a glass or glass-ceramic of the present disclosure dispersed in methyl ethyl ketone was added to 6 g of the XL-8 Plastic Coating and stirred. The solvents were allowed to evaporate, leaving the copper-containing particles dispersed throughout the polyvinyl chloride.

For Example 2D, 0.75 g of copper-containing particles in the form of a glass or glass-ceramic of the present disclosure dispersed in methyl ethyl ketone was added to 6 g of the XL-8 Plastic Coating along with 0.63 g of 2-ethylhexyl phosphate as an additive. The solvents were allowed to evaporate, leaving the copper-containing particles and the 2-ethylhexyl phosphate dispersed throughout the polyvinyl chloride.

For Example 2E, 0.124 g of copper-containing particles in the form of a copper salt, specifically tetrakis(acetonitrile)copper(I) hexafluorophosphate, dissolved in acetonitrile was added to 6 g of the XL-8 Plastic Coating. The solvents were allowed to evaporate, leaving ions of the copper nitrile complex, specifically [Cu(CH₃CN)₄]⁺, dispersed throughout the polyvinyl chloride.

For Example 2F, 0.124 g of copper-containing particles in the form of a copper salt, specifically tetrakis(acetonitrile)copper(I) hexafluorophosphate, dissolved in acetonitrile was added to 6 g of the XL-8 Plastic Coating along with 0.21 g of 2-ethylhexyl phosphate as an additive. The solvents were allowed to evaporate, leaving ions of the copper nitrile complex, specifically [Cu(CH₃CN)₄]⁺, and 2-ethylhexyl phosphate dispersed throughout the polyvinyl chloride.

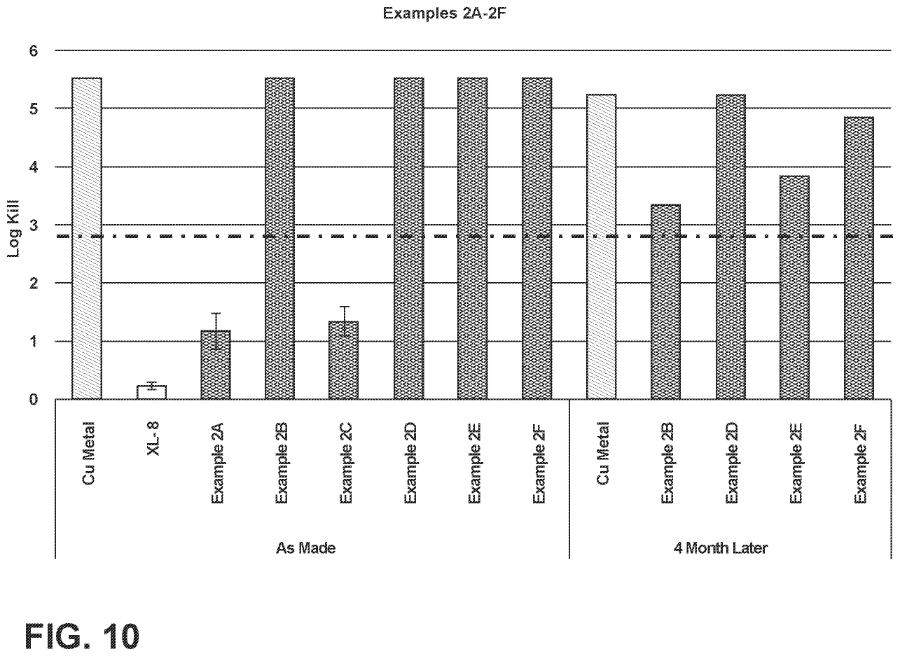

Referring now to FIG. 10, all of Examples 2A-2F were evaluated for antimicrobial efficacy pursuant to Modified JIS Z 2801 for Bacteria testing conditions (i) as formed and (ii) four months after formation. Copper metal and XL-8 Plastic Coating were evaluated as well for comparison. Examples 2A and 2C verses Examples 2B and 2D demonstrate that the inclusion of an additive (e.g., 2-ethylhexyl phosphate) in Examples 2B and 2D increases the antimicrobial activity of the as made polymeric material when the copper containing particles are glass or glass-ceramic copper containing particles. Both Examples 2B and 2D exhibit as made log kill antimicrobial activity of greater than 5. In addition, Examples 2E and 2F illustrate that the as made polymeric material including ions of a copper nitrile complex (e.g., [Cu(CH₃CN)₄]⁺) exhibits log kill antimicrobial activity of greater than 5, even when the polymeric material lacks an additive as in Example 2E.

However, referring still to FIG. 10, the antimicrobial efficacy of the Examples 2D and 2F, which include the additive (e.g., 2-ethylhexyl phosphate), was greater four months after formation than Examples 2B and 2E. More specifically, Examples 2D and 2F containing the additive (e.g., 2-ethylhexyl phosphate) exhibited a log kill of greater than 4 (with Example 2D being greater than 5), while Examples 2B and 2E not containing the additive exhibited a log kill of less than 4. However, even Examples 2B and 2E, which did not include the additive, still exhibited a log kill of greater than 3 after four months from formation.

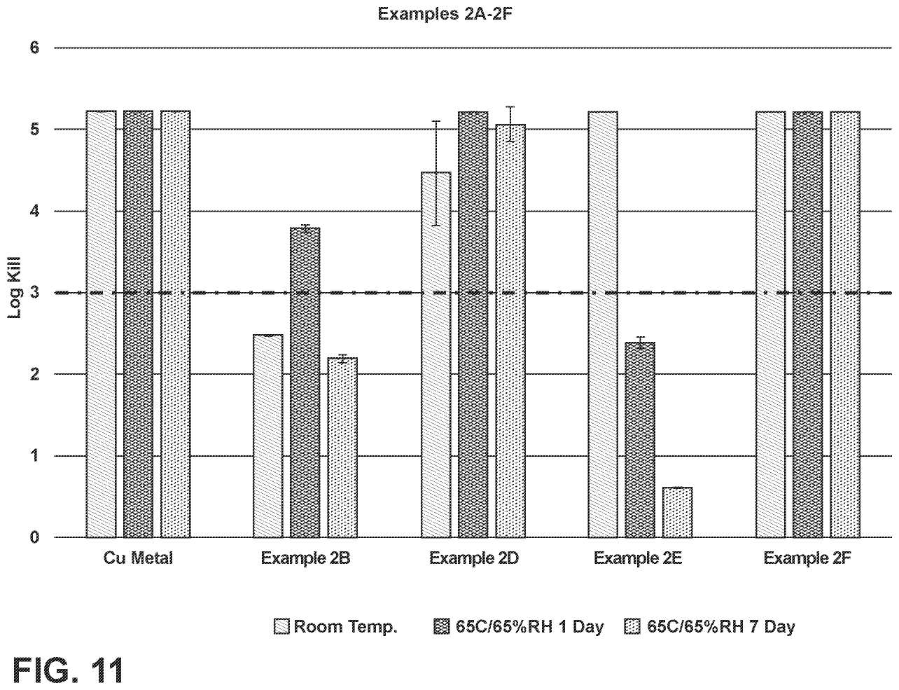

Referring now to FIG. 11, the antimicrobial efficacy of various of Examples 2A-2F at room temperature and after accelerated aging were measured. The measurements occurred approximately one month after formation of the Examples. Two different accelerated aging conditions were implemented—(i) 1 day of accelerated aging at 65° C. and 65% relative humidity, and (ii) 7 days of accelerated aging at 65° C. and 65% relative humidity. The results are illustrated at FIG. 11. The antimicrobial efficacy of copper metal was evaluated as well, as a control.

Example 2D compared to Example 2B illustrates that the greater the weight percentage of the copper-containing particles of glass or glass-ceramic dispersed in the polymeric material along with the additive (e.g., 2-ethylhexyl phosphate), the greater the antimicrobial efficacy after accelerated aging. More specifically, in Example 2D, the copper-containing particles of glass or glass-ceramic were 10 wt % of the polymeric material, and exhibited a log kill of greater than 5 after both accelerated aging of one day and seven days.

However, in Example 2B, the copper-containing particles of glass or glass-ceramic were 3.9 wt %, and exhibited a log kill of below 4 after one day of accelerated aging and a log kill of below 3 after seven days of accelerated aging.

Still referring to FIG. 11, Example 2F compared to Example 2E illustrates that the inclusion of the additive (e.g., ethylhexyl phosphate) in the polymeric material with the ions of the copper nitrile complex (e.g., [Cu(CH₃CN)₄]⁺) results in the polymeric material maintaining a high antimicrobial efficacy despite accelerated aging, while the polymeric material without the additive does not so result. More specifically, in Example 2F, the polymeric material included the additive (e.g., ethylhexyl phosphate) in addition to the ions of the copper nitrile complex (e.g., [Cu(CH₃CN)₄]⁺). The polymeric material of Example 2F exhibited a log kill of greater than 5 after both one day accelerated aging and seven day accelerated aging. However, in Example 2E, the polymeric material did not include the additive (e.g., ethylhexyl phosphate) in addition to the ions of the copper nitrile complex (e.g., [Cu(CH₃CN)₄]⁺) and exhibited a log kill of less than 3 after one day accelerated aging and less than 1 after seven days accelerated aging. The room temperature antimicrobial efficacies that the Examples exhibited (and reported at FIG. 11) differ slightly from the antimicrobial efficacies that the Examples exhibited “as made” (and reported at FIG. 10) perhaps due to the approximate one-month aging that occurred between the measurements. Other conclusions can be drawn from FIGS. 10 and 11.

1. A polymeric material comprising:
a polymer;
ions of a copper nitrile complex dispersed throughout the polymer; and
an additive dispersed throughout the polymer, the additive comprising one or more of 2-ethylhexylphosphate, imidazole, benzoxazole, benzimidazole, benzothiazole, benzopyrrole, phthalimide, urea, a nitrile, a pyrrole, an indole, a maleimide, a succinimide, an organo-phosphate, an organo-phosphite, and an organo-phosphonate.

2.-11. (canceled)

12. A polymeric material comprising:
a polymer,
copper-containing particles dispersed throughout the polymer,
copper-containing ions dispersed throughout the polymer, and
an additive dispersed throughout the polymer, the additive selected from the group consisting of N-methyl-2-pyrrolidone, dimethylformamide, acetamide, formamide, 2-pyrrolidone, N-formylmorpholine, urea, β-propiolactam, δ-valerolactam, ε-caprolactam, acetonitrile, benzonitrile, 2-ethylhexylphosphate, imidazole, benzoxazole, benzimidazole, benzothiazole, benzopyrrole, phthalimide, urea, a nitrile, imidazole, a pyrrole, an indole, a maleimide, a succinimide, an organo-phosphate, an organo-phosphite, and an organo-phosphonate;
wherein, after 7 days of accelerated aging at 65° C. and 65% relative humidity, the polymeric material exhibits a 3 log reduction or greater in a concentration of at least one of Staphylococcus aureus and Pseudamonas aeruginosa, under Modified JIS Z 2801 for Bacteria testing conditions.

13. The polymeric material of claim 12, wherein
the polymer is one or more of a nylon, polyvinyl chloride, a polyester, polybutylene terephthalate, polypropylene, polyethylene, polyethyleneimine, an aramid precursor polymer, polyetherimide, a polyamide-imide, polystyrene, poly(methyl methacrylate), polyimide, melamine resin, urea-formaldehyde, polyacrylonitrile, a copolyimide, an amine-containing polymer, an amide-containing polymer, an imide-containing polymer, a pyrrole-containing polymer, and an indole-containing polymer.

14. The polymeric material of claim 12, wherein
the polymer is one or more of an amine-containing polymer, an amide-containing polymer, and an imide-containing polymer.

15. The polymeric material of claim 12, wherein
the copper-containing particles comprise one or more of a glass, a glass-ceramic, cuprite crystals, metallic copper, copper oxide, and a copper salt.

16. The polymeric material of claim 15, wherein
the copper-containing particles comprise a glass or glass-ceramic, and
the glass or glass-ceramic is 30 wt % to 50 wt % of the polymeric material.

17. The polymeric material of claim 15, wherein
the copper-containing particles comprise a copper salt, and
the copper salt is a salt of a copper nitrile complex.

18. The polymeric material of claim 17, wherein
the copper salt is tetrakis(acetonitrile)copper(I) hexafluorophosphate.

19. The polymeric material of claim 17, wherein
the copper salt is within a range of from 0.5 wt % to 5 wt % of the polymeric material.

20. The polymeric material of claim 12, wherein
the polymeric material exhibits a 3 log reduction or greater in a concentration of at least one of Staphylococcus aureus and Pseudamonas aeruginosa, under Modified JIS Z 2801 for Bacteria testing conditions.

21. (canceled)

22. The polymeric material of claim 12 wherein
after 7 days of accelerated aging at 65° C. and 65% relative humidity, the polymeric material exhibits a 5 log reduction or greater in a concentration of at least one of Staphylococcus aureus and Pseudamonas aeruginosa, under Modified JIS Z 2801 for Bacteria testing conditions.

23.-50. (canceled)

51. The polymeric material of claim 12, wherein the copper-containing particles comprise a copper salt.

52. The polymeric material of claim 51, wherein the copper salt comprises a copper halide.

53. The polymeric material of claim 12, wherein the copper-containing particles comprise one or more of a glass, a glass-ceramic, and cuprite crystals.

54. The polymeric material of claim 12, wherein the copper-containing particles comprise copper oxide.

55. The polymeric material of claim 12, wherein the copper-containing ions are derived from the copper-containing particles.

56. The polymeric material of claim 12, wherein the additive is an organo-phosphite.

57. The polymeric material of claim 12, wherein the additive is an organo-phosphonate.

58. The polymeric material of claim 12, wherein the additive is an organo-phosphate.

59. The polymeric material of claim 12, wherein the polymer is one or more of a nylon, polyvinyl chloride, a polyester, polystyrene, and poly(methyl methacrylate).
